(19) United States
(12) Patent Application Publication
(10) Pub. No.: US 2008/0185976 A1
(43) Pub. Date: Aug. 7, 2008

(54) DISPLAY BACKLIGHT SYSTEM AND METHOD

(75) Inventors: Bill A. Dickey, Corrales, NM (US); Michael R. Praiswater, Albuquerque, NM (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/671,202

(22) Filed: Feb. 5, 2007

(51) Int. Cl. H05B 37/02

(52) U.S. Cl. 315/294

(57) ABSTRACT

A system and method for controlling backlight luminance of a display that includes a display region in which an image may be selectively rendered includes one or more devices for determining if operation in a reduced power mode is desired. If operation in the reduced power mode is not desired, the display region is at least substantially uniformly backlit. If operation in the reduced power mode is desired, only selected sections of the display region are selectively backlit.

### TECHINICAL FIELD

The present invention relates to displays, and more particularly, to a system and method of controlling a display backlight.

### BACKGROUND

Backlights are used in transmissive displays, such as liquid crystal displays (LCDs), to enhance user visibility of the display under various conditions by illuminating the display. Although the overall structure and configuration may vary, a typical backlight includes a plurality of light sources that are placed behind the display. The light sources, when appropriately energized, emit light and illuminate the display. Various types of light source backlights have been developed and used. For example, incandescent light, electroluminescent (EL) light, cold cathode fluorescent lamp (CCFL), hot cathode fluorescent lamp (HCFL), and light emitting diode (LED) backlights, just to name a few, have been developed and used.

In some instances, it may be desirable to operate a display, and more specifically the display backlight, in a reduced power operational mode. For example, depending on the end-use of the display, it may be desirable to operate the display in a reduced power mode for various off-nominal operating conditions, for thermal management purposes, and/or for battery management purposes. Backlights are typically designed to produce substantially uniform luminance for the entire display region. Thus, even when the display is operated in a reduced power mode, each of the light sources may be energized, albeit at a reduced power level, even though the entire display may not be needed during the reduced power mode. This can potentially exacerbate the condition and/or purpose for being in the reduced power operational mode.

Hence, there is a need for a system and method of controlling display backlights that, when the need arises to operate the display in a reduced power mode, the backlight does not potentially exacerbate the condition and/or purpose for being in the reduced power operational mode. The present invention addresses at least this need.

### BRIEF SUMMARY

In one embodiment, and by way of example only, a backlight system for a display includes a plurality of light sources and a backlight controller. Each light source is coupled to be selectively energized and deenergized and is operable, upon being energized to emit light and illuminate a portion of the display. The backlight controller is configured to determine if reduced power operation is desired and, if so, to selectively deenergize selected ones of the light sources and selectively energize selected other ones of the light sources.

In another exemplary embodiment, a display system includes a display, a backlight, and a backlight controller. The display includes a display region in which an image may be selectively rendered. The backlight is spaced apart from the display region and includes a plurality of light sources. Each light source is coupled to be selectively energized and deenergized and operable, upon being energized, to emit light. The backlight controller is coupled to the backlight and is configured to determine if reduced power operation is desired, energize each light source in a manner that at least substantially uniformly backlights the display region if reduced power operation is not desired, and selectively deenergize selected ones of the light sources and selectively energize selected other ones of the light sources in a manner that selectively backlights only selected sections of the display region if reduced power operation is desired.

In yet another exemplary embodiment, a method of controlling backlight luminance of a display that includes a display region in which an image may be selectively rendered includes determining if operation in a reduced power mode is desired. If operation in the reduced power mode is not desired, the display region is at least substantially uniformly backlit. If operation in the reduced power mode is desired, only selected sections of the display region are selectively backlit.

### BRIEF DESCRIPTION OF THE DRAWINGS

FIG. 1 is a cross-sectional view of an exemplary backlit display in accordance with an exemplary embodiment of the present invention;

FIG. 2 is a front view of the exemplary display of FIG. 1 depicting, in simplified form, the division of the display region into multiple sections; and

FIG. 3 is a functional block diagram of an exemplary display backlight control system that may be used with the exemplary displays depicted in FIGS. 1 and 2.

### DETAILED DESCRIPTION OF A PREFERRED EMBODIMENT

The following detailed description is merely exemplary in nature and is not intended to limit the invention or the application and uses of the invention. Furthermore, there is no intention to be bound by any theory presented in the preceding background or the following detailed description.

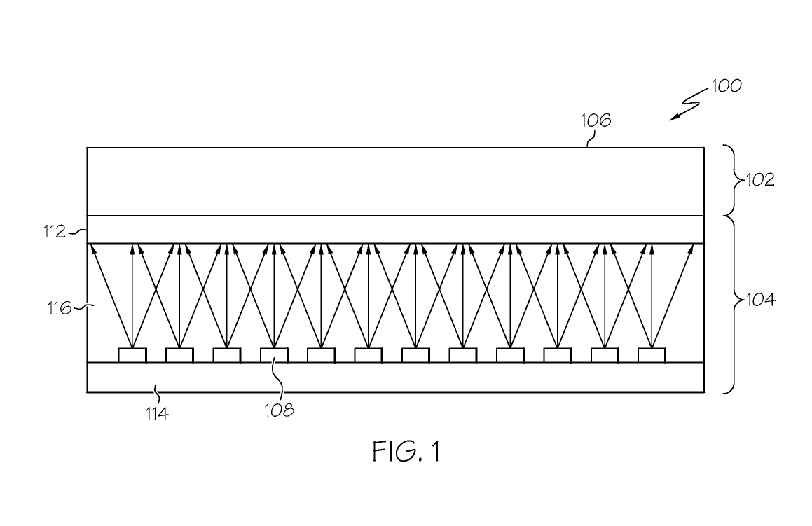

FIG. 1 is a simplified cross-sectional view of an exemplary embodiment of a display device 100 that may be used, for example, as an avionics display. The display device 100 includes a display 102 and a backlight 104. The display 102 is preferably implemented as a liquid crystal display (LCD) 102, and includes a display region 106 in which one or more images may be rendered. It will be appreciated that the display 102 may be implemented in accordance with any one of numerous LCD configurations, now known or developed in the future. Indeed, a description of the particular structure of the LCD 102 is not needed to fully describe or enable the invention encompassed in the accompanying claims. As such, no further description of its structure will be provided herein.

The backlight 104 is coupled to the display 102, and includes a plurality of light sources 108, and a diffuser 112. The light sources 108 are each coupled to a substrate 114, which is spaced apart from the display 102 to form a backlight cavity 116 therebetween. The light sources 108 are each configured, upon being energized, to emit light toward the display 102. The light sources 108 are preferably implemented using a plurality of white LEDs. It will be appreciated, however, that the light sources 108 could be implemented using a plurality of color LEDs, incandescent lights, electroluminescent (EL) lights, cold cathode fluorescent lamps, or hot cathode fluorescent lamps, just to name a few.

No matter how the light sources 108 are each implemented, the light rays that are emitted from the light sources 108 optically mix in the backlight cavity 116 and enter the diffuser 112. The diffuser 112, as is generally known, statistically redirects the optically mixed light rays from the backlight cavity 116 and preferably distributes the mixed light rays toward the display 102 with substantial uniformity.

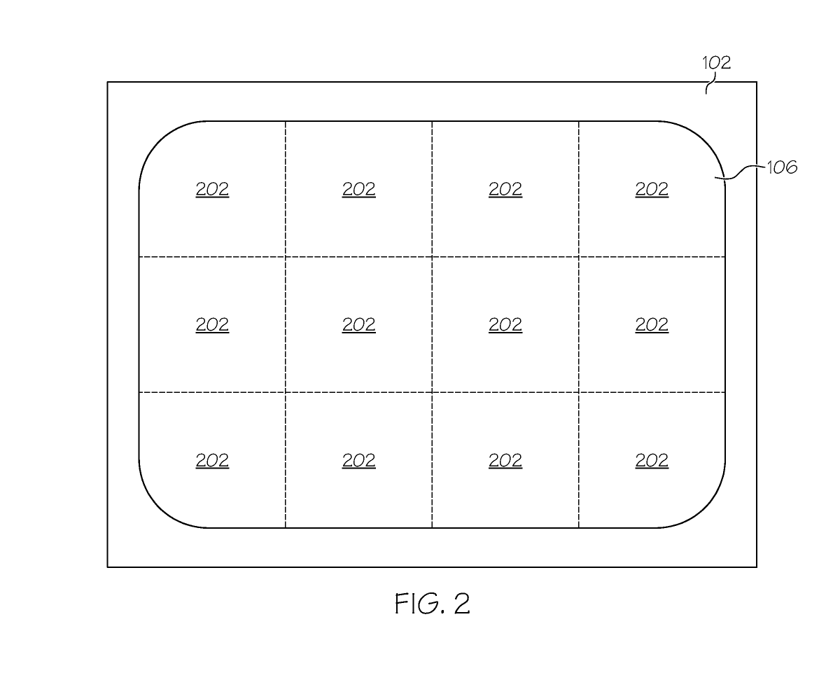

The display device 100, as noted above, may be used as an avionics display. An avionics display, as is generally known, is used to render a plurality of images representative of various types of data and/or aircraft status for display to a pilot. These data and/or status may vary, and may include, for example, aircraft speed, aircraft altitude, aircraft attitude, and aircraft heading, just to name a few. Thus, the display 102 may be configured to render a plurality of images, each in different sections of the display region 106. For example, in the embodiment depicted in FIG. 2, the display region 106 may, in at least one particular configuration, render different images in up to twelve different display region sections 202. It will be appreciated that the embodiment in FIG. 2 is, for ease of depiction and description, a simplified representation of the number and configuration of the different display region sections 202 that may be implemented by the display 102. The display 102 could be configured to implement more or less than this number of display region sections 202, and in varying sizes, shapes, and configurations.

Before proceeding further, it is noted that the display 102 may be configured to render the plurality of images in the display region 104 using any one of numerous processes now known or developed in the future. A description of these processes is not needed to fully describe or enable the invention encompassed in the accompanying claims. As such, no further description of the processes will be provided herein.

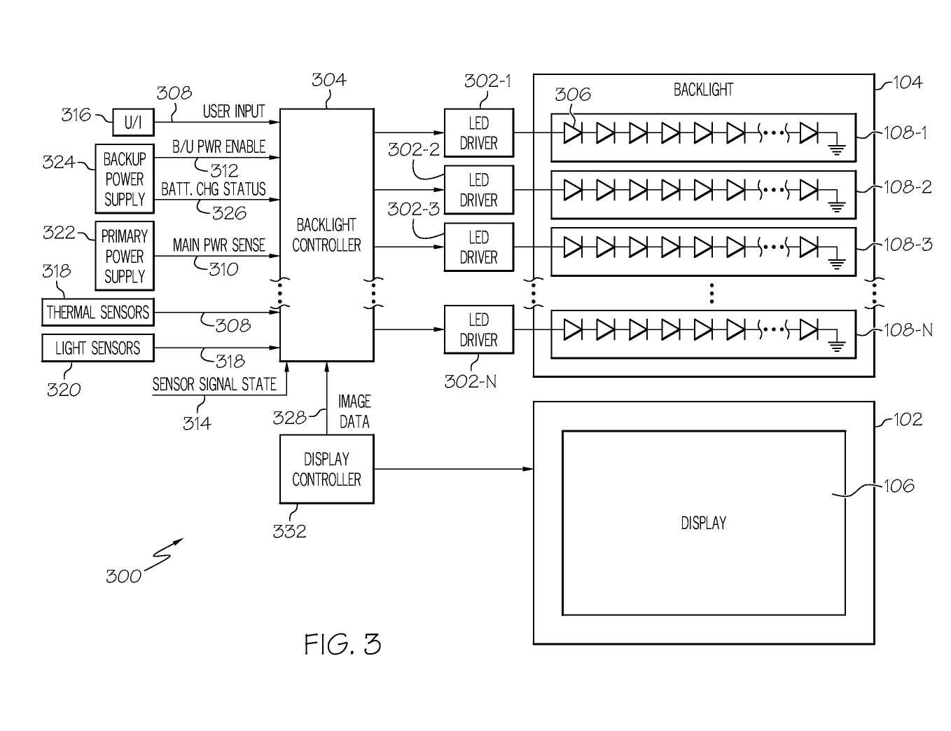

Turning now to FIG. 3, a description of an exemplary backlight control system that may be used to control the display backlight 104 will be provided. The backlight control system 300, at least in the depicted embodiment, includes a plurality of drivers 302 and a backlight controller 304. The drivers 302 are each coupled to, and are each independently controlled to selectively energize, one of the light sources 106. As was noted above, the light sources 106 are implemented using LEDs, and most preferably white LEDs. In the embodiment depicted in FIG. 3, it is seen that each light source 108 is preferably implemented as a plurality of LEDs 306. The LEDs 306 that comprise each light source 108 are electrically coupled in series or in series-parallel. For ease of illustration, the LEDs 306 are depicted as being electrically coupled in series. It will be appreciated that the number of drivers 302 (e.g., 302-1, 302-2, 302-3, . . . 302-N) and the light sources 106 (e.g., 106-1, 106-2, 106-3, . . . 106-N) may vary. Preferably, and as will become apparent from the descriptions further below, the number of each will depend, for example, on the how many different display region sections 202 of which it is desired to independently control the backlight luminance. It will additionally be appreciated that the number and type of LEDs 306 that comprise each individual light source 106 may vary.

The backlight controller 304 is coupled to, and independently controls, each of the drivers 302, and thus independently controls which light sources 106 are energized and deenergized. More specifically, the backlight controller 304 is configured to determine if reduced power operation of the display device 100 is desired. If the backlight controller 304 determines that reduced power operation is not desired, then it preferably energizes, via the drivers 302, of each of the light sources 106. If, however, the backlight controller 304 determines that reduced power operation is desired, it selectively deenergizes, via the drivers 302, selected ones of the light sources 106 and selectively energizes, via the drivers 302, selected other ones of the light sources 106. It will be appreciated that the light sources 106 that are energized and deenergized during the reduced power operation may vary with one or more system conditions that resulted in the desire, or continued desire, for reduced power operation. For example, under some reduced power operation conditions, it may be desirable to only deenergize one or two of the light sources 106, whereas under other reduced power operation conditions it may be desirable to deenergize all but one or two of the light sources. Moreover, situations could be encountered in which the reduced power operation condition may initially result in only one or two of the light sources 106 being deenergized; however, as time goes it on may be desirable to selectively deenergize additional light sources 106. It will additionally be appreciated that the backlight controller 304 may also be configured to independently control the luminance levels of the energized light sources 106, at least during reduced power operational modes. In addition, it will be appreciated that in some embodiments the drivers 302 could be formed as an integral part of the backlight controller 304.

The backlight controller 304 is preferably responsive to one or more input signals to determine whether reduced power operation of the display device 100. In the depicted embodiment these input signals include a user input signal 306, a thermal sensor signal 308 that is representative of the thermal state of the display device 100, a signal representative of primary power supply state 310, a signal representative of backup power supply state 312, and a signal representative of the state of one or more sensor signals 314. The user input signal 306 is supplied from a user interface 316. The user interface 316 is provided so that a user can manually place the backlight controller 304 into the reduced power operation. Although the user interface 316 may be implemented using various user interface devices, it is configured, in response to user stimuli supplied thereto from a user, to selectively supply the user input signal 306 to the backlight controller 304.

The thermal sensor signal 308 is supplied either directly or indirectly from one or more thermal sensors 318 (only one depicted in FIG. 3). The thermal sensor 318 senses the thermal state of the display device 100, or selected portions thereof, and supplies a thermal sensor signal representative thereof. If the thermal sensor 318 senses that the display device 100, or portions thereof, are operating at an undesirably high temperature, the backlight controller 304, in response to the thermal sensor signal 308, may determine that it is desirable to operate in a reduced power mode. The signal representative of one or more sensor signals 314 is supplied from one or more non-illustrated sensors, either directly or indirectly, or via non-illustrated processing circuitry. This signal 314 includes data that indicates whether the sensor signals supplied from the one or more non-illustrated sensors are lost and/or invalid. The particular sensors may vary, but in an aircraft environment the sensors may be, for example, the various sensors used to supply sensor signals representative of aircraft flight status and that are displayed in the display region 106.

The signal representative of primary power supply state 310 is supplied either directly or indirectly from a display device primary power supply 322 and indicates, for example, whether the primary power supply 322 is operating properly, improperly, or not at all. The signal representative of backup power supply state 312 is supplied either directly or indirectly from a display device backup power supply 324 and indicates, for example, whether the backup power supply 324 is being used to supplying power to the display device 100 and, if it is, whether it is operating properly. The backup power supply 324 may be implemented as a redundant power supply that is substantially identical to the primary power supply, or it may be implemented using a battery. It will be appreciated that if the backup power supply 324 is implemented using a battery, a signal representative of battery charge status 326 may also be supplied to the backup controller 304, and the backup controller 304 may be further responsive to this signal to, for example, control which light sources 106 are energized and deenergized during operation in the reduced power operational mode, and the luminance levels associated with the energized light sources 106.

The backlight controller 304 additionally receives one or more feedback signals 318 from one or more light sensors 320 (only one depicted in FIG. 3). The light sensors 320, which may be implemented using photodetectors, sense the luminance level of the light emitted from one or more of the energized light sources 106, and supplies a feedback signal 318 representative thereof to the backlight controller 304. The backlight controller 304, as noted above, may use this feedback signal 318 to control the luminance levels of one or more of the energized light sources 106. The backlight controller 304 may be configured to control light source luminance levels when a reduced power operational mode is not desired, when a reduced power operational mode is desired, or both.

As FIG. 3 also depicts, the backup controller 304 may additionally be in operable communication with, and receive image data 328 from, a display controller 332. The display controller 332 receives various data from various non-illustrated sources and, in response, causes various images to be displayed in the display region 106. The image data 328 that are supplied to the backlight controller 304 are representative of the images that the display controller 332 is causing to be rendered in the display region 106. The backlight controller 304 may be further configured, upon receipt of the image data, to determine which light sources 106 to energize and deenergize. It will be appreciated that the backlight controller 304 may be operable to implement this functionality when reduced power operation is desired, when reduced power operation is not desired, or both. It will additionally be appreciated that the functions of the backlight controller 304 and the display controller 332 could be implemented by a single device.

With the above-described configuration, the backlight controller 304, based on the above-described signals that are supplied thereto, determines if operation of the display device 100 in a reduced power mode is desired. If the backlight controller 304 determines that operation in the reduced power mode is not desired, the backlight controller 304 will energize, via the drivers 302, each of the light sources 108 to uniformly (or at least substantially uniformly) backlight the display region 106. If, however, the backlight controller determines that operation in the reduced power mode is desired, the backlight controller 304 will selectively backlight only selected sections 202 of the display region 106 by selectively deenergizing selected ones of the light sources 108 and selectively energizing selected other ones of the light sources 108. As noted above, the backlight controller 304 may additionally independently control the luminance levels of the energized light sources 106 to further reduce the power consumption by the backlight 104.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

We claim:

1. A backlight system for a display, comprising:
a plurality of light sources, each light source coupled to be selectively energized and deenergized and operable, upon being energized to emit light and illuminate a portion of the display;
a backlight controller configured to determine if reduced power operation is desired and, if so, to selectively deenergize selected ones of the light sources and selectively energize selected other ones of the light sources.

2. The backlight system of claim 1, wherein the backlight controller is further configured to energize each light source if reduced power operation is not desired.

3. The backlight system of claim 1, wherein:
the backlight controller is adapted to receive an input signal; and
the backlight controller is responsive to the input signal to determine if reduced power operation is desired.

4. The system of claim 3, further comprising:
a user interface in operable communication with the backlight controller, the user interface configured to receive input stimuli from a user and, in response to the user stimuli, to selectively supply the input signal.

5. The system of claim 3, wherein the input signal is at least representative of representative of the thermal state of the display.

6. The system of claim 3, wherein:
the backlight controller is adapted to receive power from a power supply; and
the input signal is at least representative of the power supply state.

7. The system of claim 6, wherein:
the power supply is either a primary power supply or a backup power supply; and
the input signal is at least representative of which power supply is supplying power to the backup controller.

8. The system of claim 3, wherein the input signal is at least representative of the state of one or more sensor signals.

9. The system of claim 1, wherein:
the backlight controller is adapted to receive image data representative of images to be rendered by the display; and
the backlight controller is further configured, upon receipt of the image data, to selectively deenergize selected ones of the light sources and selectively energize selected other ones of the light sources.

10. The system of claim 1, wherein the backlight controller is further configured to selectively reduce electrical power supplied to the selectively energized light sources.

11. The system of claim 1, wherein each light source comprises a plurality of light emitting diodes (LEDs).

12. A display device, comprising:
a display including a display region in which an image may be selectively rendered;
a backlight spaced apart from the display region and including a plurality of light sources, each light source coupled to be selectively energized and deenergized and operable, upon being energized, to emit light; and
a backlight controller coupled to the backlight, the backlight controller configured to:
(i) determine if reduced power operation is desired,
(ii) energize each light source in a manner that at least substantially uniformly backlights the display region if reduced power operation is not desired, and
(iii) selectively deenergize selected ones of the light sources and selectively energize selected other ones of the light sources in a manner that selectively backlights only selected sections of the display region if reduced power operation is desired.

13. The display device of claim 12, wherein the backlight controller is responsive to an input signal to determine if reduced power operation is desired.

14. The display device of claim 13, further comprising:
a user interface in operable communication with the backlight controller, the user interface configured to receive input stimuli from a user and, in response to the user stimuli, to selectively supply the input signal.

15. The display device of claim 13, further comprising:
a thermal sensor in operable communication with the backlight controller, the thermal sensor configured to sense the thermal state of the display and supply a signal representative thereof as the input signal.

16. The display device of claim 13, further comprising:
a power supply configured to supply power to the backlight controller,
wherein the input signal is at least representative of the power supply state.

17. The display device of claim 13, further comprising:
a primary power supply configured to selectively supply power to the backlight controller; and
a backup power supply configured to selectively supply power to the backlight controller,
wherein the input signal is at least representative of which power supply is supplying power to the backup controller.

18. The display device of claim 13, further comprising:
a sensor operable to supply a sensor signal to the display representative of one or more parameters to be rendered in the display region,
wherein the input signal is at least representative of the state of the sensor signal.

19. The display device of claim 13, further comprising:
a display controller in operable communication with the display and the backlight controller, the display controller configured to (i) selectively cause the image to be selectively displayed in the display region and (ii) to supply image data representative of the image to be rendered,
wherein the backlight controller is adapted to receive the image data and is further configured, upon receipt of the image data, to selectively deenergize selected ones of the light sources and selectively energize selected other ones of the light sources.

20. The display device of claim 12, wherein the backlight controller is further configured to selectively reduce electrical power supplied to the selectively energized light sources.

21. The display device of claim 12, wherein each light source comprises a plurality of light emitting diodes (LEDs).

22. A method of controlling backlight luminance of a display, the display including a display region in which an image may be selectively rendered, the method comprising the steps of:
determining if operation in a reduced power mode is desired;
at least substantially uniformly backlighting the display region if operation in the reduced power mode is not desired; and
selectively backlighting only selected sections of the display region if operation in the reduced power mode is desired.
